(19) United States
(12) Patent Application Publication
(10) Pub. No.: US 2007/0204749 A1
(43) Pub. Date: Sep. 6, 2007

(54) GAS CHROMATOGRAPH COLUMN AND METHOD OF MAKING THE SAME

(76) Inventor: Douglas Adkins, Albuquerque, NM (US)

Correspondence Address: V. Gerald Grafe, esq., P.O. Box 2689, Corrales, NM, 87048, US

(21) Appl. No.: 11/678,616

(22) Filed: Feb. 25, 2007

Related U.S. Application Data
(60) Provisional application No. 60/777,777, filed on Mar. 1, 2006.
(60) Provisional application No. 60/779,747, filed on Mar. 7, 2006.

(51) Int. Cl. B01D 53/02

(52) U.S. Cl. 96/101

(57) ABSTRACT

The present invention includes a gas chromatograph column and method of making the same that provide a substantial advance in the art of gas chromatography. The gas chromatograph column includes a first manifold defining a first internal fluid path, a second manifold defining a second internal fluid path and a plurality of tubes. Each of the plurality of tubes defines a fluid path therein, and is mountable with the first manifold and the second manifold such that the first internal fluid path is in fluid communication with the second internal fluid path. Additional features of the present invention include heating and cooling capabilities for ensuring proper fluid flow as welt as the ability to align two or more gas chromatograph columns in series or in parallel for analysis of one or more samples simultaneously.

### CROSS REFERENCE TO RELATED APPLICATIONS

The present application claims priority to provisional application Ser. No. 60/777,777, entitled “Micro Gas Sample Collector/Injector” filed Mar. 1, 2006, and provisional application Ser. No. 60/779,747, entitled “Miniature Gas Chromatography Column Comprised of a Capillary Tube Array”, filed Mar. 1, 2006, the specifications of both of which are incorporated herein in their entirety.

### TECHNICAL FIELD

The present invention relates generally to the field of chemical analysis, and more particularly to the field of gas chromatography and gas composition analysis.

### BACKGROUND AND HISTORY OF THE RELATED ART

Gas chromatography is a standard technique for separating compounds in gas samples for composition analysis. Typically, a gas sample is injected into a fused silica capillary column, and constituents of the sample separate based on each constituent compound's affinity for a coating on the interior wall of the capillary. Some compounds move rapidly through the column exhibiting little interaction with the column's coating, while other compounds move slowly through the column because of strong interactions with the coating.

Gas chromatography columns are typically 1 to 30 meters long, and have an inner diameter of 50 to 300 microns. Creating a compact gas chromatography (GC) column is challenging because it is difficult to bend fused silica capillaries to a radius much smaller than 100 mm. In the late 1990's, techniques were developed to etch spiral channels in silicon and cover the channel with a lid to produce rectangular cross-section columns (e.g., Overton, U.S. Pat. No. 6,068,684). Heaters or coolers are attached to these columns to provide controlled temperature profiles that aid in sample separations (e.g., Manginell, et al, U.S. Pat. No. 6,666,907 and Robinson, et al, U.S. Pat. No. 6,706,091)

Recently, techniques have been developed to produce circular cross section columns in nickel from stacked sheets with an array of holes (e.g., Rahimian and Lewis, December 2005, Pacifichem Conference). In this process, nickel is deposited on a plastic mold to form a thin sheet with an array of holes. Multiple sheets are stacked together to form an array of columns. Through the same deposition process, sheets with an array of slots are formed in nickel, and the slotted-sheets are stacked on the sheets with holes in such a way to form a continuous, serpentine passage. The entire stack is diffusion bonded together to create a single-chip GC column. With GC columns formed in this process, a 1-meter long column can be packaged in a chip that is approximately 13-mm on each side 1-mm thick. Longer columns have been formed by adding layers of hole-patterned sheets to the stack.

A drawback to the nickel micro-GC column is that multiple sheets with an array of holes are used in forming the stack. The thickness of the sheet is dictated by the time allocated to the deposition process; typically, each layer will be only 250 microns thick, so 4 layers, with a 30 by 30 array of holes, are required to make a 1 meter column. Each of these sheets must be accurately aligned in the stack to insure a uniform column, and each of the layers must be lapped flat and parallel to insure that the seal formed in diffusion bonding is hermetic. Also, the cross-section is not perfectly circular in the slotted passages that link holes in the array. A cross-section that is uniform throughout the column can achieve the best chromatography. In a 30×30 array of these holes, there are 900 such slotted inter-linking passages that will perturb the flow profile through the nickel micro-GC column. Reducing the number of flow perturbations can be important to improve chromatography.

There is a need in the art for an improved gas chromatograph that reduces the number of flow perturbations and improves overall performance while minimizing the time and expense necessary for designs manufacture, and assembly of the apparatus.

### SUMMARY OF THE PRESENT INVENTION

The present invention can provide a gas chromatograph column and method of making the same that solve a number of the foregoing problems and provide a substantial advance in the art of gas chromatography. The gas chromatograph column, which is described by way of detailed examples below, includes a first manifold defining a first internal fluid path, a second manifold defining a second internal fluid path, and a plurality of tubes. According to the various example embodiments described below, each of the plurality of tubes defines a fluid path therein, and is mountable with the first manifold and the second manifold such that the first internal fluid path is in fluid communication with the second internal fluid path. One advantage of the example embodiments of the present invention is that by minimizing the lapping and aligning processes used in the construction methods of the prior art, the flow profile of the gas chromatograph column is improved.

The present invention further includes a method of making a gas chromatograph column. The method generally includes the steps of: providing a first manifold defining a first internal fluid path, providing a second manifold defining a second internal fluid path, providing a plurality of tubes, and mounting the plurality of tubes to the first manifold and the second manifold such that a substantially serpentine fluid path is formed between the first manifold and the second manifold. Various method of mounting of the plurality of tubes to the first and second manifolds are described in detail below, as well as suitable materials, geometries and dimensions for the gas chromatograph.

Further details and advantages of the present invention are described below with reference to several example embodiments that are illustrated in the following figures.

### BRIEF DESCRIPTION OF THE FIGURES

FIG. 1 is a perspective exploded view of a gas chromatograph column in accordance with an example embodiment of the present invention.

FIG. 2 is a perspective exploded view of a gas chromatograph column in accordance with an example embodiment of the present invention.

FIG. 3 is a perspective exploded view of a gas chromatograph column in accordance with an example embodiment of the present invention.

FIG. 4 is a perspective view a portion of a gas chromatograph column in accordance with an example embodiment of the present invention.

FIG. 5 is a perspective view of an array of gas chromatograph columns in accordance with an example embodiment of the present invention.

FIG. 6 is a perspective view of a portion of a gas chromatograph column in accordance with an example embodiment of the present invention.

FIG. 7 is a perspective, partially exposed view of a gas chromatograph column system in accordance with an example embodiment of the present invention.

FIG. 8 is a perspective exploded view of a gas chromatograph column in accordance with an example embodiment of the present invention.

FIG. 9 is a perspective exploded view of a gas chromatograph column in accordance with an example embodiment of the present invention.

FIG. 10 is a perspective exploded view of a gas chromatograph column in accordance with an example embodiment of the present invention.

FIG. 11 is a perspective and cross-sectional view of an array of gas chromatograph columns in accordance with an example embodiment of the present invention.

### DETAILED DESCRIPTION OF THE EXAMPLE EMBODIMENTS

The following description of various example embodiments of the invention is not intended to limit the invention to any single preferred embodiment, but rather to enable a person skilled in the chromatographic arts to make and use the invention.

The present invention, described with reference to its example embodiments, can provide a gas chromatograph column and a method of making the same. In particular, the gas chromatograph column of the example embodiments includes a first manifold defining a first internal fluid path, a second manifold defining a second internal fluid path, and a plurality of tubes. According to the various example embodiments, each of the plurality of tubes defines a fluid path therein, and is mountable with the first manifold and the second manifold such that the first internal fluid path is in fluid communication with the second internal fluid path. As described in more detail below, one advantage of the example embodiments of the present invention is that by minimizing the lapping and aligning processes used in the construction methods of the prior art, the flow profile of the gas chromatograph column is improved.

The gas chromatograph column described herein offers several advantages. First, there are fewer interconnections between parts so it introduces fewer perturbations on the flow pattern than the hole-array micro-gas chromatograph column. Second, there are fewer lapping processes since the tubes are not formed as a stack of sheets with holes. Also, forming a longer tube does not introduce more lapping procedures since only the ends of the tubes are lapped. There are fewer joints in the gas chromatograph column of the example embodiments, so it is less likely that leakage can occur between adjacent columns of the tube array. Finally, longer tubes can be created by linking multiple gas chromatograph column arrays through a common manifold as described in detail below.

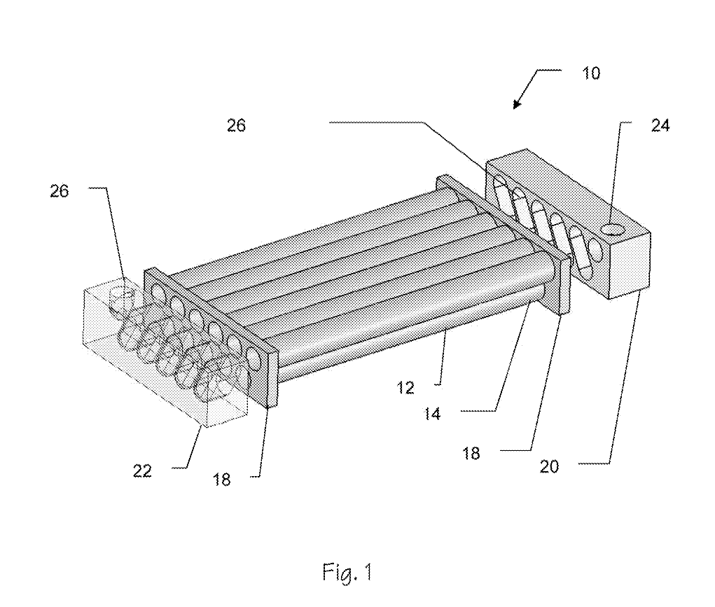

One example embodiment of a gas chromatograph 10 of the present invention is shown in FIG. 1. The gas chromatograph column 10 of the example embodiment includes a plurality of tubes 12, which can for example be aligned into an array of varying geometries as further described herein. Each of the plurality of tubes 12 defines a first end 14 and a second end 16, which as shown in this example embodiment can be lapped flat and mutually parallel and sealed to (or in) one or more headers 18. The headers 15 can be formed through chemical etching, mechanical machining, electrical discharge machining or ultrasonic machining.

As used herein, the term tube refers to any elongated passage through which fluid may flow, including any and all functional geometries and cross-sections, including at least circular, elliptical, parabolic, hyperbolic and polygonal cross-sections. Additionally, any or all of the plurality of tubes 12 can have differing geometries, cross-sections and either uniform or variable diameters along their respective lengths. Moreover, each of the plurality of tubes 12 defines an inner diameter, which can be uniform or variable throughout the plurality of tubes 12 as a group and can be uniform or variable throughout each individual tube of the plurality of tubes 12. A suitable inner diameter can be dependent on the particular application and materials;, for many applications and common materials a diameter less than about five hundred microns is suitable, which provides for a compact and efficient gas chromatograph 10.

The first end 14 of the plurality of tubes 12 is mountable with a first manifold 20, while the second end 16 of the plurality of tubes 12 is mountable with a second manifold 22. Both the first manifold 20 and the second manifold 22 can be formed through processes such as chemical etching, mechanical machining, electrical discharge machining or ultrasonic machining, each of which can have its own requirements, advantages, and disadvantages. Each of the first and second manifolds 20, 22 are attachable to the headers 18, or alternatively the plurality of tubes 12 can be directly mounted to the first and second manifolds 20, 22. Each of the first and second manifolds 20, 22 defines an internal fluid path, which functions to link the plurality of tubes 12 into one or more continuous passages. In one example embodiment, the internal fluid path 26 can include a plurality of passages 26 that define a substantially semi-toroidal geometry for receiving a fluid through one of the plurality of tubes 12 and directing the fluid into another of the plurality of tubes 12 such that the first internal fluid path is in communication with the second internal fluid path.

In the example embodiment shown in FIG. 1, the first manifold 20 further defines an external port 24 and the second manifold 22 defines an external port 28. Each of the external ports 24, 28 are adapted for fluid communication with an external element, such as for example a gas sample transport line, a gas collection container, or a third manifold that is in fluid communication with a fourth manifold. For example, the external ports 24, 28 can be provided in the first and second manifolds 20, 22 to allow the introduction and/or removal of gas samples, or the augmentation and creation of a larger gas chromatograph having more than two manifolds as described in further example embodiments.

In the example embodiment shown in FIG. 1, the plurality of tubes 12 can be composed of a number of suitable materials, including for example nickel, stainless steel, electroformed nickel, silver, ceramics, glass tubing or polycarbonates. In the example embodiment, the plurality of tubes 12 can be passivated in order to avoid the presence or development of active sites that can hold onto constituent portions of an analysis sample. Additionally, each of the plurality of tubes 12 can have one or more coatings applied to its interior surface to aid in separating gaseous species. Example coatings include one or more stationary materials adapted to facilitate separation of the constituent portions of an analysis sample. Suitable stationary materials include for example, polymers, zeolites, polyethylene glycol and polysiloxane.

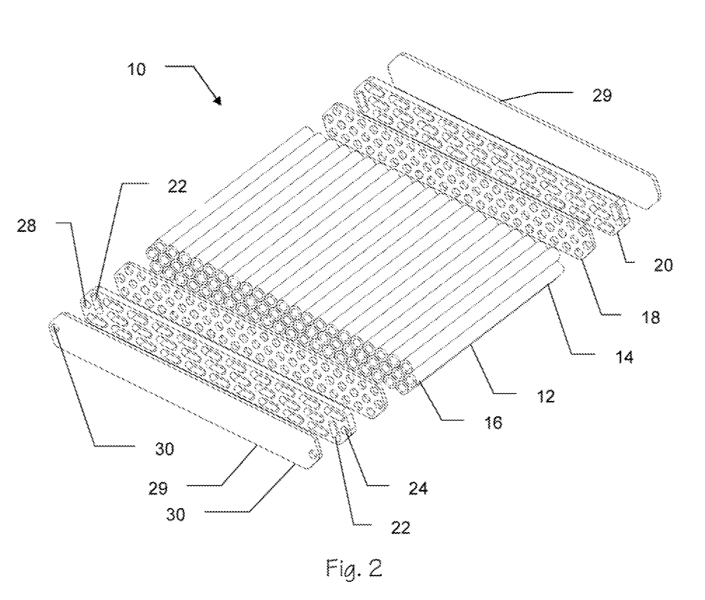

In another example embodiment, shown in FIG. 2, the gas chromatograph 10 includes a plurality of tubes 12, which can for example be aligned into an array of varying geometries as further described herein. Each of the plurality of tubes 12 defines a first end 14 and a second end 16, which as shown in this example embodiment can be lapped flat and mutually parallel and sealed to (or in) one or more headers 18, which are shown having openings for receiving the plurality of tubes 12 and mating with a first manifold 20 and a second manifold 22. In the example embodiment, each of the plurality of tubes 12 defines an inner diameter, which as noted above, can be uniform or variable throughout the plurality of tubes 12 as a group and may be uniform or variable throughout each individual tube of the plurality of tubes 12. A suitable inner diameter includes any diameter less than fifty microns, which provides for a compact and efficient gas chromatograph column 10, and any or all of the plurality of tubes 12 can have variable or standardized geometries and cross-sections.

The first end 14 of the plurality of tubes 12 is mountable with the first manifold 20, while the second end 16 of the plurality of tubes 12 is mountable with the second manifold 22, through the respective headers 18 shown herein. Each of the first and second manifolds 20, 22 are attachable to the headers 18. Each of the first and second manifolds 20, 22 defines an internal fluid path, which functions to link the plurality of tubes 12 into one or more continuous passages. In one example embodiment, the internal fluid path 26 can include a plurality of passages 26 that define a substantially semi-toroidal geometry for receiving a fluid through one of the plurality of tubes 12 and directing the fluid into another of the plurality of tubes 12 such that the first internal fluid path is in communication with the second internal fluid path.

In the example embodiment shown in FIG. 2, the gas chromatograph column 10 further includes first and second cover plates 29 mountable with the first manifold 20 and the second manifold 22, respectively. In this example embodiment, the second manifold 22 defines a pair of external ports 24, 26, which are mountable in alignment with cover plate ports 30 for fluid communication with an external element. As in the prior embodiment, the external element can include for example a gas sample container, a gas removal container, or a third manifold that is in fluid communication with a fourth manifold. For example, the external ports 24, 26 can be provided in the second manifold 22 to allow the introduction and/or removal of gas samples, or the augmentation and creation of a larger gas chromatograph column having more than two manifolds as described in further example embodiments.

In the example embodiment shown in FIG. 2, the plurality of tubes 12 can be composed of a number of suitable materials, including for example nickel, stainless steel or electroformed nickel. In the example embodiment, the plurality of tubes 12 can be passivated in order to avoid the presence or development of active sites that can hold onto constituent portions of an analysis sample. Additionally, each of the plurality of tubes 12 can have one or more coatings applied to its interior surface to aid in separating gaseous species. Example coatings include one or more stationary materials adapted to facilitate separation of the constituent portions of an analysis sample. Suitable stationary materials include for example, polymers, zeolites, polyethylene glycol and polysiloxane.

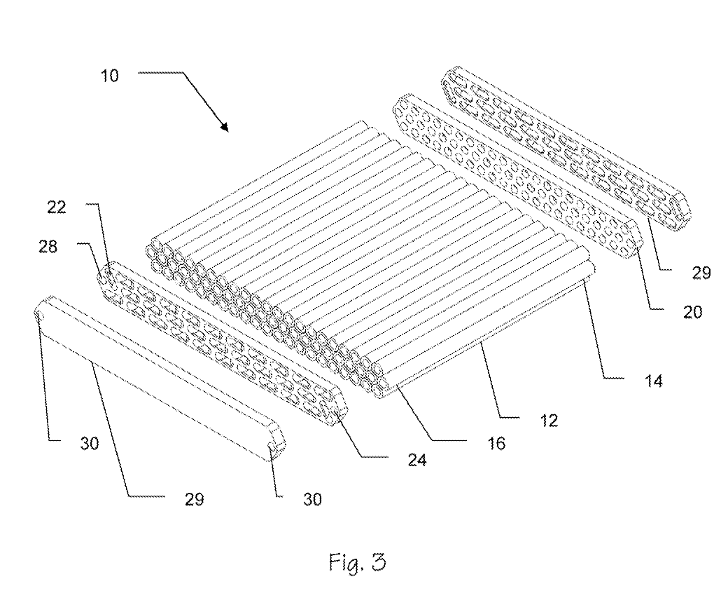

In another example embodiment shown in FIG. 3, the gas chromatograph column 10 includes a plurality of tubes 12, which as noted above can for example be aligned into an array of varying geometries as further described herein. Each of the plurality of tubes 12 defines a first end 14 and a second end 16 which as in prior embodiments can be lapped flat and mutually parallel and sealed to (or in) one or more headers 18, which are shown having openings for receiving the plurality of tubes 12 and mating with a first manifold 20 and a second manifold 22. In the example embodiment, each of the plurality of tubes 12 defines an inner diameter, which may be uniform or variable throughout the plurality of tubes 12 as a group and may be uniform or variable throughout each individual tube of the plurality of tubes 12. A suitable inner diameter can be dependent on the particular application and materials; for many applications and common materials a diameter less than about five hundred microns is suitable, which provides for a compact and efficient gas chromatograph 10.

The first end 14 of the plurality of tubes 12 is mountable with the first manifold 20, while the second end 16 of the plurality of tubes 12 is mountable with the second manifold 22, through the respective headers 18 shown herein. Each of the first and second manifolds 20, 22 are attachable to the headers 18, or alternatively the plurality of tubes 12 can be directly mounted to the first and second manifolds 20, 22. Each of the first and second manifolds 20, 22 defines an internal fluid path, which functions to link the plurality of tubes 12 into one or more continuous passages. In one example embodiment, the internal fluid path 26 can include a plurality of passages 26 that define a substantially semi-toroidal geometry for receiving a fluid through one of the plurality of tubes 12 and directing the fluid into another of the plurality of tubes 12 such that the first internal fluid path is in communication with the second internal fluid path.

In the example embodiment shown in FIG. 3, the first manifold 20 and the second manifold 22 functions both as a manifold and as a header for the plurality of tubes 12 as described above with reference to FIG. 2. In this example embodiment, the second manifold 22 defines a pair of external ports 241 26, which are mountable in alignment with cover plate 29 for fluid communication with an external element. As described above, the external element can include for example a gas sample container, a gas removal container, or a third manifold that is in fluid communication with a fourth manifold. For example, the external ports 24, 26 can be provided in the second manifold 22 to allow the introduction and/or removal of gas samples, or the augmentation and creation of a larger gas chromatograph having more than two manifolds as described in further example embodiments.

As in prior embodiments, the plurality of tubes 12 can be composed of a number of suitable materials, including for example nickel, stainless steel, electroformed nickel, silver, ceramics, glass, or polycarbonate materials. Moreover, the plurality of tubes 12 can be passivated in order to avoid the presence or development of active sites that can hold onto constituent portions of an analysis sample. Additionally, each of the plurality of tubes 12 can have one or more coatings applied to its interior surface to aid in separating gaseous species. Example coatings include one or more stationary materials adapted to facilitate separation of the constituent portions of an analysis sample. Suitable stationary materials include for example, polymers, zeolites, polyethylene glycol and polysiloxane.

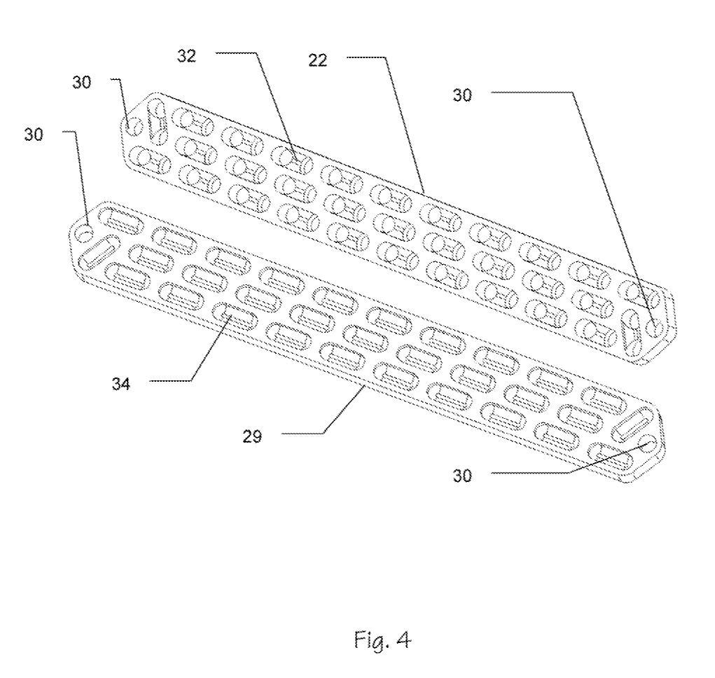

Further features of the example embodiment shown in FIG. 3 are illustrated in FIG. 4. The second manifold 22 includes a plurality of passages 32, each defining a pair of openings through which an analyte may pass in one direction. As described above, the second manifold 22 is directly mountable with the cover plate 29, which defines a pair of external ports 30 alignable with similar external ports 30 defined in the second manifold 22. The cover plate 29 further defines a plurality of interconnecting cavities 34 which are curved, beveled or shaped to define a substantially semi-toroidal geometry. Each of the plurality of interconnecting cavities 34 is alignable with one of the plurality of passages 32 in the second manifold, such that each pair of openings in the plurality of passages 32 functions in combination with the matching interconnecting cavity 34 to provide a substantially curvilinear flow of fluid, i.e. the fluid can enter through one of the pair of openings of each of the passages 32 and must exit through the other of the pair of openings of the same passage 32. In this manner, the second manifold 22 and the cover plate 29 cooperate to promote a serpentine flow of a fluid through the gas chromatograph as the fluid flows through one of the plurality of tubes 12, changes direction at the second manifold 22, and flows in the opposite direction through another of the plurality of tubes 12. It should be noted that while FIG. 4 illustrates this cooperative effect with reference to the second manifold 22, the dynamics and structure of the example embodiments are equally applicable at either one or both of the first and second manifolds 20, 22, depending upon the analytic requirements of the particular gas chromatograph column 10.

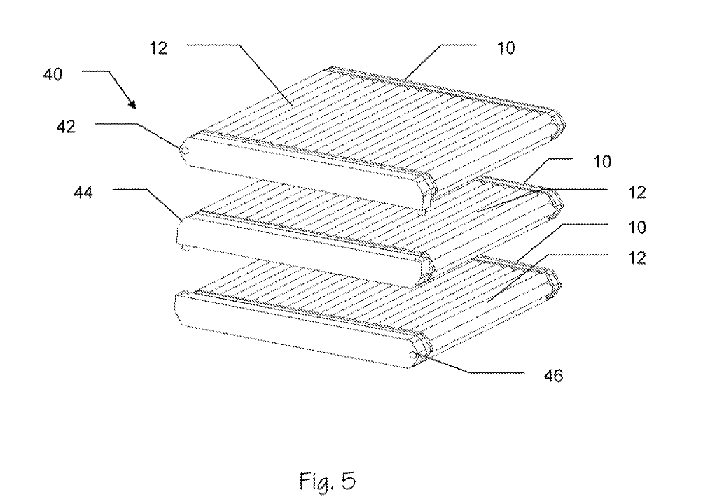

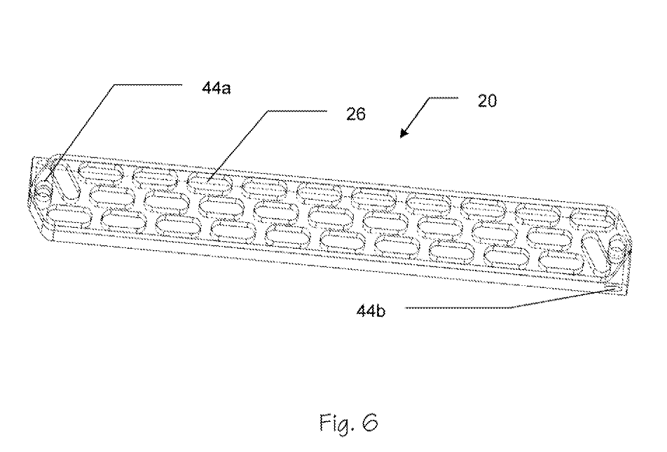

For example, FIG. 5 illustrates an example embodiment of the present invention in which an array 40 is formed from three gas chromatograph columns 10 operating in series. A fluid entering through a first of the three gas chromatograph columns 10, for example at an inlet port 42, flows through each of the remaining gas chromatograph columns 10 until it is expelled at an exit port 46. In this example embodiment, the gas chromatograph columns 10 are connectable through connecting ports 44, each of which is in fluid communication with the plurality of tubes 12 that compose a portion of each respective gas chromatograph column 10. As shown in FIG. 6, the first manifold 20 of a gas chromatograph column 10 can include one or more connecting ports 44a, 44b for receiving and distributing the fluid. For example, a fluid may enter through a first connecting port 44a, pass through the entirety of the plurality of tubes 12 (not shown in FIG. 6) mountable with each of the internal fluid paths 26, and then exit the first manifold 20 through a second connecting port 44b. As noted previously, either of the connecting ports 44a, 44b can be readily connected to any external element, including a sample container, a sample receiving, or another gas chromatograph column 10 as shown in the array 40 of FIG. 5.

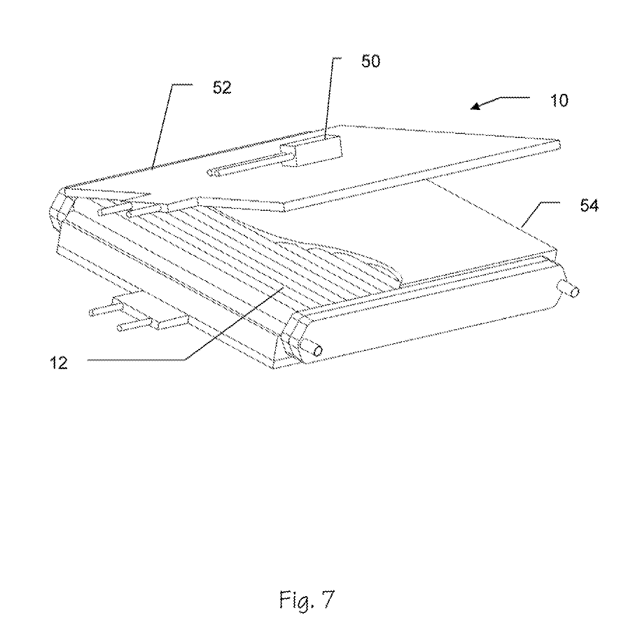

In an example embodiment shown in FIG. 7, the gas chromatograph column 10 includes a temperature control element 52 that is in thermal communication with the plurality of tubes 12. The temperature control element 52 functions to control the relative temperature of the plurality of tubes 12. In variations of the example embodiment, the temperature control element 52 can be adapted to maintain a uniform temperature throughout the plurality of tubes 12, or it can be adapted to maintain a constant, variable or temporial temperature profile in the plurality of tubes 12.

In operation, the temperature control element 52 can be used to heat and/or cool portions or the entirety of the plurality of tubes 12. For example, high vapor pressure fluids may travel too fast through any one of the plurality of tubes 12 for adequate separation of its constituents. A relative cooling of any particular one or all of the plurality of tubes 12 will cause a high vapor pressure fluid to slow down, thereby improving the separation of its constituents. Similarly, a low vapor pressure fluid may need increased heating in order to move it through the gas chromatograph column 10 in a timely manner. By varying or ramping the temperature profile of the plurality of tubes 12 as a function of time and/or space, the temperature control element 52 can encourage low vapor pressure fluids to be moved through heated portions in a timely manner while maintaining the separation of high vapor pressure fluids at relatively lower temperature profiles. The temperature profile of the plurality of tubes 12 can be varied as a function of time, space, or any combination thereof in order to ensure optimal throughput of the fluid.

As shown in FIG. 7, the example embodiment of the gas chromatograph column 10 can also include a temperature sensor 50 in thermal communication with the plurality of tubes 12. The temperature sensor 50 functions to measure temperature changes within the plurality of tubes 12, and may further be connected with the temperature control element 52 for providing temperature-related feedback and assisting in the temperature control of the plurality of tubes 12. In a variation of the example embodiment, the gas chromatograph column 10 can also include a thermal potting 54 disposed about the plurality of tubes 12 for aiding in the conduction of heat in either a heating or cooling process. The thermal potting 54 can be composed of a suitable low-mass material that would ensure the thermal responsiveness of the gas chromatograph column 10. Suitable materials for the thermal potting 54 include for example braze compounds, solders, and/or thermally conductive epoxies.

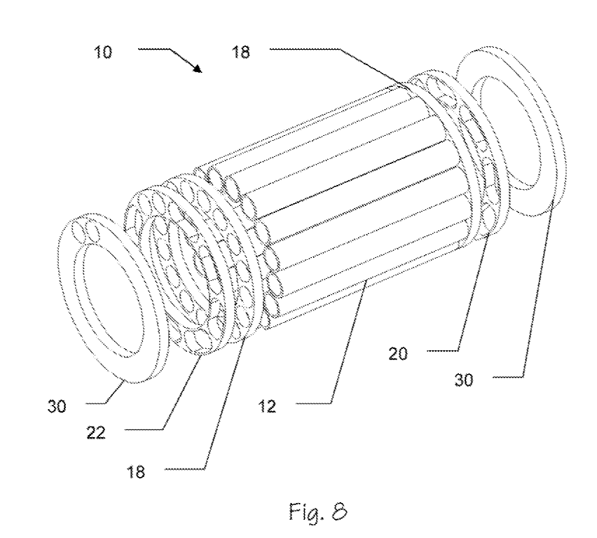

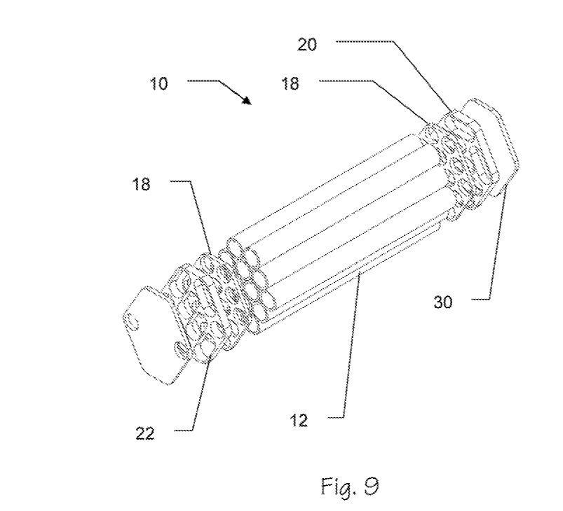

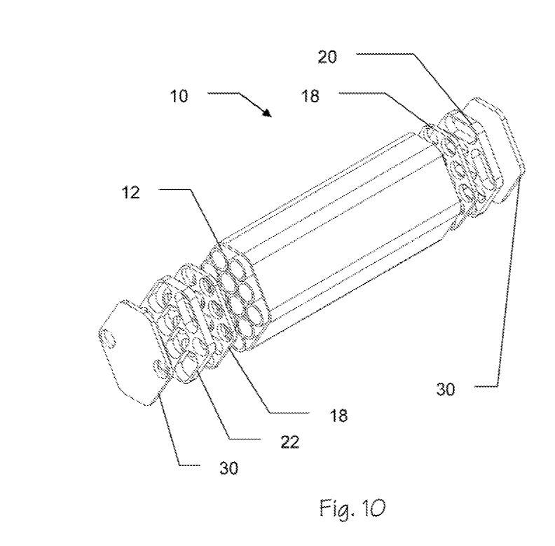

Tubular construction permits the development of several configurations that may be beneficial for packaging and/or temperature control. Example embodiments of these configurations are shown in FIGS. 8, 9, and 10. FIG. 8 shows a ring design where heating can take place on the outer surface of the ring, and air-cooling can take place down the center of the ring. The present invention can also provide a gas chromatograph column 10 formed in a compact bundle as is illustrated in FIG. 9. As applicable to any of these designs, a shell 60 as shown in FIG. 10 can be used to align the plurality of tubes 12 and other elements in the gas chromatograph column 10. The shell 60 can be beneficial in assembling and handling the gas chromatograph column 10, and in attaching temperature control elements to the plurality of columns 12.

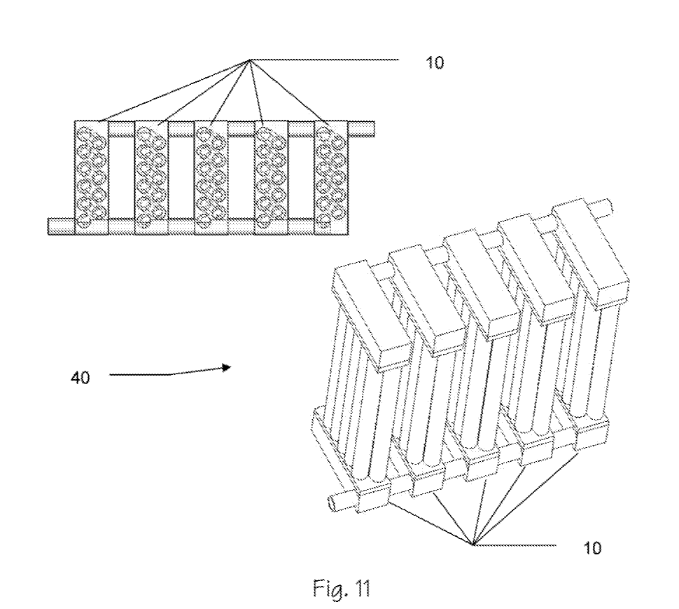

FIG. 11 illustrates an example embodiment in which a plurality of gas chromatograph columns 10 can form a parallel array 40 for fast gas chromatographic analysis on a sample. In this example embodiment, a fluid sample is introduced simultaneously into several independent gas chromatograph columns 10, each having a plurality of tubes with each tube having an internal diameter typically of a few tens of microns. Smaller diameters can allow more frequent interactions between the stationary phase on the tube wall and the gas sample to perform better sample separations with shorter length columns. Other configurations for running multiple columns in parallel are also contemplated by the present invention. In the example embodiment shown in FIG. 11, the manifolds are constructed so that pressure drops are balanced between the tubes and flow rates are equal. This allows each sample constituent to elute at the same time from each parallel gas chromatograph column 10 to prevent mixing of separated constituents.

The present invention further provides a method of making a gas chromatograph. One example embodiment of the method includes the steps of, providing a first manifold defining a first internal fluid path, providing a second manifold defining a second internal fluid path, providing a plurality of tubes, and mounting the plurality of tubes to the first manifold and the second manifold such that a substantially serpentine fluid path is formed between the first manifold and the second manifold. Mounting of the plurality of tubes to the first and second manifolds can be accomplished, for example, through brazing or diffusion bonding. As used herein, the term serpentine is defined as any path by which a fluid can proceed from one of the plurality of tubes, through the first manifold and into a second of the plurality of tubes towards the second manifold.

In a variation of the example method, the first internal fluid path comprises a plurality of passages through which fluid may flow and the second internal fluid path comprises a plurality of passages through which fluid may flow. As shown and described above, the plurality of passages found in the first and second manifolds define a substantially semi-toroidal geometry for receiving a fluid through one of the plurality of tubes and directing the fluid into another of the plurality of tubes such that the first internal fluid path is in communication with the second internal fluid path.

In another variation of the example method, the first manifold further defines an external port and the second manifold defines an external port. Each of the external polls are adapted for fluid communication with an external element, such as for example a gas sample container, a gas removal container, gas transport lines, or a third manifold that is in fluid communication with a fourth manifold. For example, the external ports can be provided in the first and second manifolds to allow the introduction and/or removal of gas samples, or the augmentation and creation of a larger gas chromatograph column having more than two manifolds as described in detail above with reference to the Figures.

Another variation of the example method includes the steps of mounting a temperature control element in thermal communication with the plurality of tubes and mounting a temperature sensor in thermal communication with the plurality of tubes. The temperature sensor can be adapted to measure temperature changes within the plurality of tubes. As noted above, the temperature control element can be used to heat and/or cool portions or the entirety of the plurality of tubes. For example, high vapor pressure fluids may travel too fast through any one of the plurality of tubes for adequate separation of its constituents. A relative cooling of any particular one or all of the plurality of tubes will cause a high vapor pressure fluid to slow down, thereby improving the separation of its constituents. Similarly, a low vapor pressure fluid may need increased heating in order to move it through the gas chromatograph column in a timely manner. By varying or ramping the temperature profile of the plurality of tubes as a function of time and/or space, the temperature control element ensures that low vapor pressure fluids are moved through heated portions in a timely manner while maintaining the separation of high vapor pressure fluids at relatively lower temperature profiles. Variation of the temperature profile of the plurality of tubes as a function of time, space, or any combination thereof in order to ensure optimal throughput of the fluid.

As in the various example embodiments described above, the plurality of tubes can be composed of a number of suitable materials, including for example nickel, stainless steel, electroformed nickel, silver, ceramics, glass or polycarbonate materials. Moreover, the plurality of tubes can be passivated in order to avoid the presence or development of active sites that can hold onto constituent portions of an analysis sample. Additionally, each of the plurality of tubes can have one or more coatings applied to its interior surface to aid in separating gaseous species. Example coatings include one or more stationary materials adapted to facilitate separation of the constituent portions of an analysis sample. Suitable stationary materials include for example, polymers, zeolites, polyethylene glycol and/or polysiloxane.

The foregoing detailed description referred to several example embodiments of the present invention. One skilled in the art of gas chromatography would be able to devise numerous modifications of these example embodiments without departing from the scope of the present invention, which is defined below in the following claims.

I claim:

1. A gas chromatograph column comprising;
a first manifold defining a first internal fluid path;
a second manifold defining a second internal fluid path; and
a plurality of tubes, each of the plurality of tubes defining a fluid path therein, and each of the plurality of tubes further defining a first end mountable with the first manifold and a second end mountable with the second manifold such that the first internal fluid path is in fluid communication with the second internal fluid path.

2. The gas chromatograph column of claim 1 wherein the first internal fluid path comprises a plurality of passages through which fluid may flow.

3. The gas chromatograph column of claim 1 wherein the second internal fluid path comprises a plurality of passages through which fluid may flow.

4. The gas chromatograph column of claim 1 wherein the first manifold further defines an external port such that the first manifold is adapted for fluid communication with an external element.

5. The gas chromatograph column of claim 4 wherein the external element is a third manifold in fluid communication with a fourth manifold through a second plurality of tubes.

6. The gas chromatograph column of claim 1 wherein the second manifold further defines an external port such that the second manifold is adapted for fluid communication with an external element.

7. The gas chromatograph column of claim 6 wherein the external element is a third manifold in fluid communication with a fourth manifold through a second plurality of tubes.

8. The gas chromatograph column of claim 1 further comprising a temperature control element in thermal communication with the plurality of tubes.

9. The gas chromatograph column of claim 8 further comprising a temperature sensor in thermal communication with the plurality of tubes, wherein the temperature sensor is adapted to measure temperature changes within the plurality of tubes.

10. The gas chromatograph column of claim 1 wherein the plurality of tubes comprise nickel, stainless steel, electroformed nickel, silver, an alloy of the preceding, ceramics, glass, or polycarbonate materials.

11. The gas chromatograph column of claim 1 further comprising a stationary material disposed on an interior surface of the plurality of tubes, wherein the stationary material comprises one of polysiloxane, polyethylene glycol, a polymer, a zeolite, or a combination thereof.

12. The gas chromatograph column of claim 1 further comprising manifolds formed in two halves to produce a fluid passage with a substantially circular cross-section.

13. A method of making a gas chromatograph comprising
(a) providing a first manifold defining a first internal fluid path;
(b) providing a second manifold defining a second internal fluid path;
(C) providing a plurality of tubes, each of the plurality of tubes defining a fluid path therein, and each of the plurality of tubes further defining a first end mountable with the first manifold and a second end mountable with the second manifold; and
(d) mounting the plurality of tubes to the first manifold and the second manifold such that a substantially serpentine fluid path is formed between the first manifold and the second manifold.

14. The method of claim 13 wherein the first internal fluid path comprises a plurality of passages through which fluid may flow.

15. The method of claim 13 wherein the second internal fluid path comprises a plurality of passages through which fluid may flow.

16. The method of claim 13 wherein the first manifold further defines an external port such that the first manifold is adapted for fluid communication with an external element.

17. The method of claim 16 wherein the external element is a third fluid manifold in fluid communication with a fourth fluid manifold through a second plurality of tubes.

18. The method of claim 13 wherein the second manifold further defines an external port such that the second manifold is adapted for fluid communication with an external element.

19. The method of claim 18 wherein the external element is a third fluid manifold in fluid communication with a fourth fluid manifold through a second plurality of tubes.

20. The method of claim 13 further comprising the step of:
(e) connecting one of the first or second manifolds to a third manifold, wherein the third manifold is in fluid communication with a fourth manifold through a second plurality of tubes, thereby forming an array of gas chromatographs.

21. The method of claim 13 further comprising the step of:
(e) mounting a temperature control element in thermal communication with the plurality of tubes.

22. The method of claim 13 further comprising the step of:
(e mounting a temperature sensor in thermal communication with the plurality of tubes wherein the temperature sensor is adapted to measure temperature changes within the plurality of tubes.

23. The method of claim 13 wherein the plurality of tubes comprise nickel, stainless steel, electroformed nickel, silver, an alloy of the preceding, ceramics, glass, or polycarbonate materials.

24. The method of claim 13 further comprising the step of,
(e depositing a stationary material disposed on an interior surface of the plurality of tubes, wherein the stationary material comprises one of polysiloxane, polyethylene glycol, a polymer or a zeolite.

25. The method of claim 13 where the manifolds can be formed in two halves to produce internal passages with substantially circular cross-sections.

26. The method of claim 13 wherein step (d) includes mounting the plurality of tubes to the first manifold and the second manifold using brazing or diffusion bonding.

27. A gas chromatograph column according to claim 1, wherein the first internal fluid path comprises a plurality of subpaths, where each subpath places a pair of the plurality of tubes in fluid communication.

28. A gas chromatograph column according to claim 27 wherein the second internal fluid path comprises a plurality of subpaths, where each subpath places one pair of the plurality of tubes in fluid communication and where each pair of tubes placed in fluid communication by the second internal fluid path is not placed in direct fluid communication with each other by the first internal fluid path.

29. A gas chromatograph column comprising multiple parallel paths and manifolds mounted with the paths such that the manifolds and paths provide a chromotagraph column, and wherein the manifolds provide substantially equal pressure drops encouraging substantially equal flowrates through each of the parallel paths.

30. A gas chromatograph column as in claim 1 further comprising a jacket mounted with the periphery of the tube array to aid in alignment for the fabrication of the gas chromatograph column and distribution of heat in the finished column.
